(19) United States
(12) Patent Application Publication
(10) Pub. No.: US 2021/0245294 A1
(43) Pub. Date: Aug. 12, 2021

(54) SCANNING LIGHT SOURCE MODULE

(71) Applicant: Industrial Technology Research Institute, Hsinchu (TW)

(72) Inventors: Kuang-Yao Huang, Kaohsiung City (TW); Chien-Jung Huang, Tainan City (TW); Kun-Tso Chen, Kaohsiung City (TW); Hsuan-Chang Lee, Tainan City (TW)

(73) Assignee: Industrial Technology Research Institute, Hsinchu (TW)

(21) Appl. No.: 16/881,010

(22) Filed: May 22, 2020

(30) Foreign Application Priority Data
Feb. 12, 2020 (TW) 109104360

(51) Int. Cl. B23K 26/03; B23K 26/06

(52) U.S. Cl. CPC B23K 26/032; B23K 26/0648

(57) ABSTRACT

A scanning light source module for providing a pattern beam to a target object on a work plane is provided. The scanning light source module includes a light emitting device for providing a beam, a beam reducing/expanding device for adjusting an outer diameter of the beam, a shaping lens set for converting the beam into a pattern beam, a scanning reflective mirror set for reflecting the pattern beam to move along at least one direction, and a telecentric flat-field focusing element having an incident surface. The pattern beam has multiple parts. There is a spacing between the parts. The pattern beam is reflected to different positions on the incident surface by the rotation of the scanning reflective mirror set. There is a distance between the work plane and a focal plane of the telecentric flat-field focusing element.

### CROSS-REFERENCE TO RELATED APPLICATION

This application claims the priority benefit of Taiwan application no. 109104360, filed on Feb. 12, 2020. The entirety of the above-mentioned patent application is hereby incorporated by reference herein and made a part of this specification.

### BACKGROUND

### Technical Field

The disclosure relates to a light emitting device, and more particularly to a scanning light source module.

### Description of Related Art

Laser welding technology has advantages such as energy concentration, high-speed, adaptability to automated system integration, etc., and is one of the important technologies for welding processing. Laser welding technology applicable to welding of automobile-related bodies and sheet metal have been developing for many years, and up to recent electric vehicle battery module applications, such as electrode welding, housing packaging, and welding of rotor copper bars of electric vehicle motors, the application range and ratio have increased year by year. However, there are currently many issues requiring improvement.

In the current technology, the temperature at the center position of the molten pool formed from a Gaussian spot or a flat-top spot is too high, which is likely to cause issues such as material vaporization and splashing, molten pool denting, etc., causing the weld to be partially missing or dented, thereby affecting the processing quality. In addition, a large amount of splashing and smoking during the process will partially shield the incident energy of the laser light, thereby affecting the efficiency and quality. On the other hand, in many current products, it is necessary to reduce the situation of splashing during a welding process, such as the welding of rotor copper bars of electric vehicle motors, because the splashing during the welding process of copper generates the risk of motor short circuit. Therefore, the issue of welding splashing needs to be solved.

### SUMMARY

The disclosure provides a scanning light source module, which is adapted to provide a pattern beam to the target object located on a work plane. The scanning light source module includes a light emitting device, a beam reducing/expanding device, a shaping lens set, a scanning reflective mirror set, and a telecentric flat-field focusing element. The light emitting device is adapted to provide a beam. The beam reducing/expanding device is disposed on a transmission path of the beam and is adapted to adjust the outer diameter of the beam. The shaping lens set is disposed on the transmission path of the beam and is adapted to convert the beam into the pattern beam. A pattern presented by the pattern beam has multiple parts and there is a spacing between the parts. The scanning reflective mirror set is disposed on a transmission path of the pattern beam and is adapted to reflect the pattern beam to move along at least one direction. The telecentric flat-field focusing element has an incident surface and is disposed on the transmission path of the pattern beam, wherein the pattern beam is adapted to be reflected to different positions on the incident surface by the rotation of the scanning reflective mirror set. The pattern beam is transmitted to the target object by the telecentric flat-field focusing element. There is a distance between the work plane and a focal plane of the telecentric flat-field focusing element.

Several exemplary embodiments accompanied with figures are described in detail below to further describe the disclosure in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic view of a scanning light source module according to an embodiment of the disclosure.

FIG. 2 is a schematic view of a beam transmitting through a shaping lens set according to an embodiment of the disclosure.

FIG. 3A to FIG. 3C are respectively side views of a shaping lens set according to different embodiments.

FIG. 4 is an enlarged view of a beam emitted from a telecentric flat-field focusing element according to an embodiment.

FIG. 5A and FIG. 5B are respectively a light spot appearance and a light intensity distribution of a pattern beam in FIG. 4 when in a focused state.

FIG. 6A and FIG. 6B are respectively a light spot appearance and a light intensity distribution of the pattern beam in FIG. 4 when in a defocused state.

### DETAILED DESCRIPTION OF DISCLOSED EMBODIMENTS

The disclosure provides a scanning light source module, which can provide a pattern beam with uniform energy distribution to avoid material splashing or weld denting during a welding process, thereby improving quality of a weld formed on a target object and production efficiency thereof.

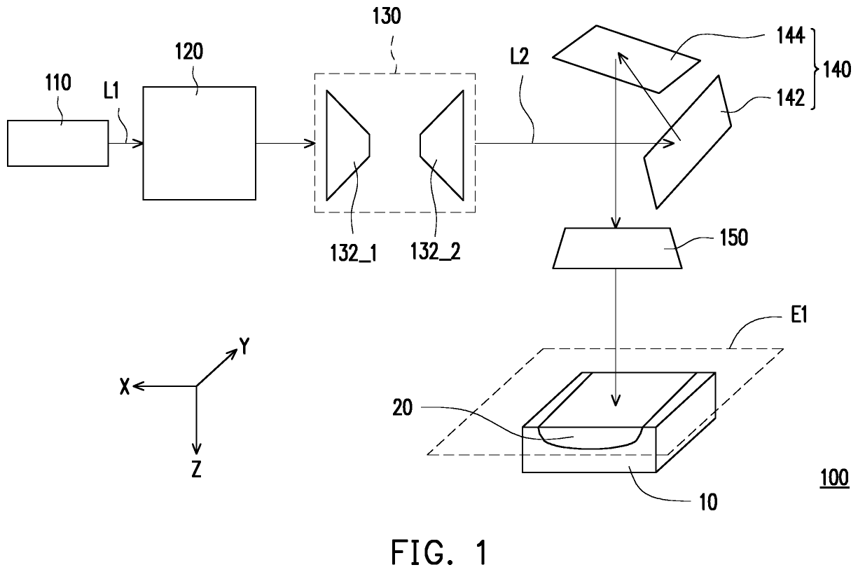

FIG. 1 is a schematic view of a scanning light source module according to an embodiment of the disclosure. Please refer to FIG. 1. An embodiment of the disclosure provides a scanning light source module 100, adapted to provide a pattern beam L2 to a target object 10 located on a work plane E1. The material of the target object 10 is a solderable material, such as a copper bar, but the disclosure is not limited thereto. Specifically, the scanning light source module 100 is configured to provide the pattern beam L2 to irradiate the target object 10, such that a weld 20 with good quality and uniform distribution may be formed on an irradiated part of the surface of the target object 10, so as to facilitate subsequent welding.

In the embodiment, the scanning light source module 100 includes a light emitting element 110, a beam reducing/expanding device 120, a shaping lens set 130, a scanning reflective mirror set 140, and a telecentric flat-field focusing element 150. The light emitting device 110 is adapted to provide a beam L1 to the beam reducing/expanding 120. In detail, the light emitting device 110 is a laser light emitting device, so the beam is a laser beam and the scanning light source module 100 may be applied to laser welding.

The beam reducing/expanding device 120 is disposed on a transmission path of the beam L1 and is adapted to adjust the outer diameter size of the beam L1, so as to change and fix the light spot size of the beam L1 to be parallelly transmitted to the shaping lens set 130. The beam reducing/expanding device 120 is, for example, a beam reducing/expanding lens, which may be formed from at least one lens having diopter, but the disclosure is not limited thereto.

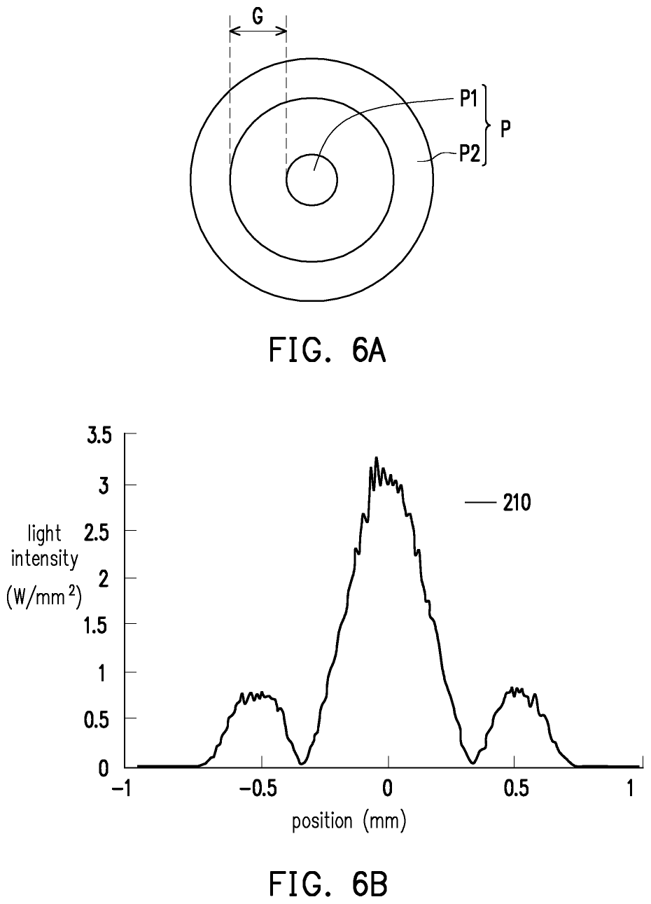

The shaping lens set 130 is disposed on the transmission path of the beam L1 and is adapted to convert the beam L1 into the pattern beam L2. Specifically, the shaping lens set 130 is disposed on the side of the beam reducing/expanding device 120 emitting the beam L1. It should be stated here that the pattern (or light spot) presented by the pattern beam L2 on the work plan E1 has multiple parts and there is a spacing G between the parts. For example, as shown in FIG. 6A, a pattern P presented by the pattern beam L2 on the work plane E1 includes a dot pattern P1 and a ring pattern P2, and there is the spacing G between the dot pattern P1 and the ring pattern P2. The detailed method of forming the ring pattern P2 will be described below.

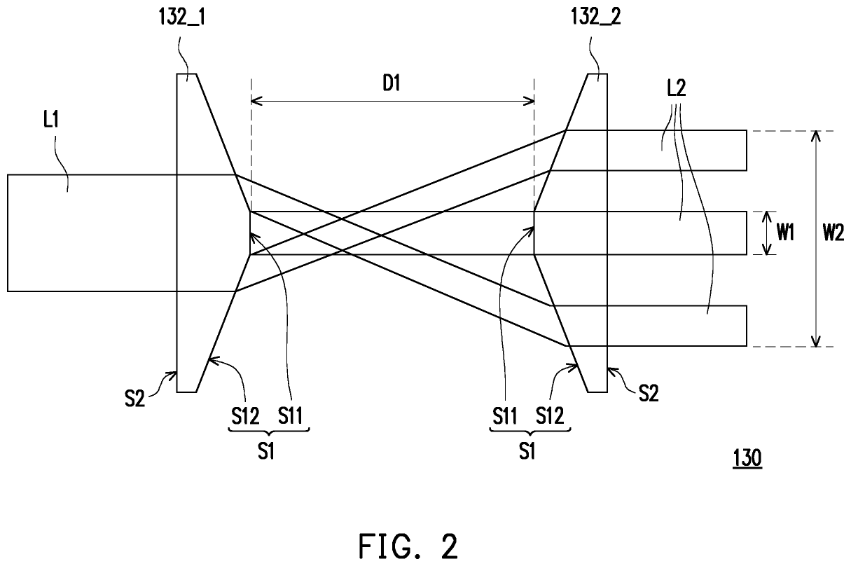

FIG. 2 is a schematic view of a beam transmitting through a shaping lens set according to an embodiment of the disclosure. Please refer to FIG. 1 and FIG. 2. A shaping lens set 130 shown in FIG. 2 may be applied to the scanning light source module 100 shown in FIG. 1, so the following description will be taking the same as an example, but the disclosure is not limited thereto. In the embodiment, the shaping lens set 130 includes two flat-top conical lenses 132_1 and 132_2. Each of the two flat-top conical lenses 132_1 and 132_2 has a flat-top surface S11 and a conical surface S12. The flat-top surface S11 and the conical surface S12 form an effective optical surface (i.e., a flat-top conical surface S1) on one side of the flat-top conical lenses 132_1 and 132_2. An effective optical surface on the other side is a plane S2. In other words, each of the flat-top conical lenses 132_1 and 132_2 has the plane S2 and the flat-top conical surface S1 on opposite sides, and the flat-top conical surface S1 is formed from the flat-top surface S11 and the conical surface S12.

Therefore, when the beam L1 is transmitted to the flat-top conical lens 132_1 by the beam reducing/expanding device 120, the center pattern of the beam L1 is transmitted to the flat-top surface S11 of the flat-top conical lens 132_1 in a straight line without refraction, so as to generate the dot pattern P1. On the other hand, the edge pattern in the beam L1 not transmitted to the flat-top surface S11 of the flat-top conical lens 132_1 (i.e., transmitted through the conical surface S12 of the flat-top conical lens 132_1) is transmitted to the conical surface S12 of the flat-top conical lens 132_2 after refraction, so as to generate the ring pattern P2, as shown in FIG. 2. In other words, the beam forming the dot pattern P1 is transmitted through the flat-top surface S11 and the beam forming the ring pattern P2 is transmitted through the conical surface S12. In this way, the beam L1 forms the pattern beam L2 having multiple pattern parts after being transmitted through the flat-top conical lenses 132_1 and 132_2.

It is worth mentioning that, in the embodiment, the outer diameter size of the beam L1 may be adjusted by the beam reducing/expanding device 120 to change the energy distribution of the pattern beam L2. The size ratio (as shown in FIG. 6A) of the dot pattern P1 to the ring pattern P2 may also be changed according to the shaping lens set 130. Specifically, adjusting a relative distance D1 between the two flat-top conical lenses 132_1 and 132_2 of the shaping lens set 130 may change a ratio of an outer diameter W1 of the part of the pattern beam L2 forming the dot pattern P1 to an outer diameter W2 of the part of the pattern beam L2 forming the ring pattern P2. In detail, the relationship between the outer diameter W1 of the part of the pattern beam L2 forming the dot pattern P1 and the outer diameter W2 of the part of the pattern beam L2 forming the ring pattern P2 may be expressed by the following Formula (1):

$${W}_{r i n g} = [ \frac{2 {W}_{c e n t e r} - D \cdot cot {θ}_{a}}{tan ( {θ}_{r} - {θ}_{a} ) - cot {θ}_{a}} \times tan ( {θ}_{r} - {θ}_{a} ) ] - {W}_{c e n t e r} , \qquad ( 1 )$$

where W_{ring} is half of the outer diameter W2 of the ring pattern P2 in the pattern beam L2; W_{center} is half of the outer diameter W1 of the dot pattern P1 in the pattern beam L2; D is the relative distance D1 between the flat-top conical lens 132_1 and the flat-top conical lens 132_2; θₐ is the included angle between the conical surface S12 and the flat-top surface S11 in the flat-top conical lens 132_1; and Or is the refraction angle of the beam L1 on the conical surface S12 in the flat-top conical lens 132_1.

It can be known that the outer diameter W2 of the ring pattern P2 changes according to the relative distance D1 between the two flat-top conical lenses 132_1 and 132_2, and the outer diameter W2 of the ring pattern P2 and the relative distance D1 between the two flat-top conical lenses 132_1 and 132_2 are inversely proportional. In this way, the energy distribution of the dot pattern P1 and the ring pattern P2 may be changed by adjusting the relative distance D1 between the two flat-top conical lenses 132_1 and 132_2.

The scanning reflective mirror set 140 is disposed on the transmission path of the pattern beam L2 and is adapted to reflect the pattern beam L2 to move along at least one direction. In detail, in the embodiment, the scanning reflective mirror set 140 includes a first reflective lens 142 and a second reflective lens 144. The first reflective lens 142 is adapted to reflect the pattern beam L2 to move along a first direction and the second reflective lens 144 is adapted to reflect the pattern beam L2 to move along a second direction, wherein the first direction is perpendicular to the second direction. For example, combinations of the first reflective lens 142 and the second reflective lens 144 respectively are, for example, scanning galvanometers of different directions. In an embodiment, the first direction is parallel to the x-axis direction, the second direction is parallel to the y-axis direction, and the first reflective lens 142 and the second reflective lens 144 are adapted to reflect the pattern beam L2 at high speed, so as to respectively move parallelly along the x-axis direction and parallelly along the y-axis direction.

The telecentric flat-field focusing element 150 has an incident surface S3 and is disposed on the transmission path of the pattern beam L2. The telecentric flat-field focusing element 150 is, for example, a telecentric F-theta lens. The telecentric flat-field focusing element 150 is adapted to focus the pattern beam L2 on a focal plane. The shape of the image (or light spot) on the focused focal plane may be maintained by the optical characteristic of the telecentric flat-field focusing element 150. In the embodiment, the pattern beam L2 is adapted to be reflected to different positions on the incident surface S3 of the telecentric flat-field focusing element 150 by the rotation of the scanning reflective mirror set 140. The pattern beam L2 is transmitted to the target object 10 by the telecentric flat-field focusing element 150. Since the pattern beam L2 may maintain a fixed pattern on the work plane E1 after passing through the telecentric flat-field focusing element 150, the pattern beam L2 is reflected by the rotation of the scanning reflective mirror set 140. Therefore, a large area laser scan may be implemented for laser welding.

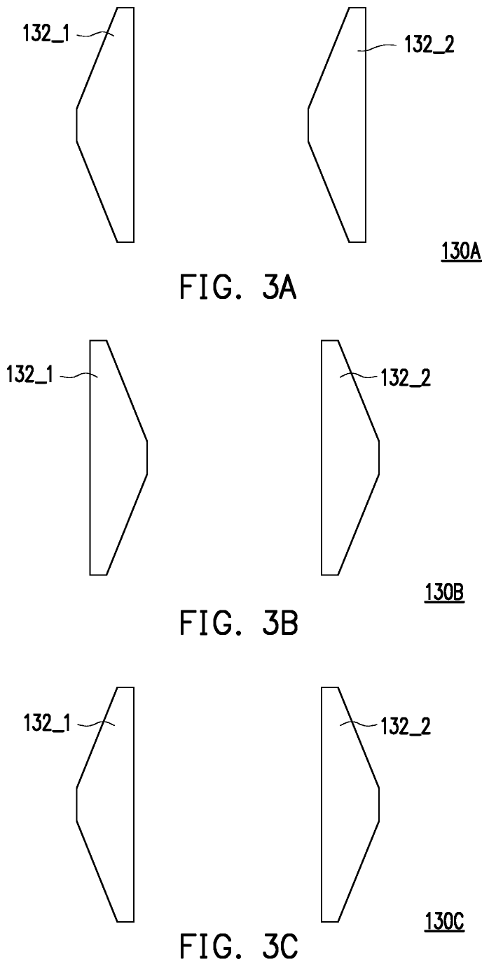

FIG. 3A to FIG. 3C are respectively side views of a shaping lens set according to different embodiments. Please refer to FIG. 3A to FIG. 3C. It should be noted that, in the shaping lens set 130 of FIG. 2, the configurational directions of the two flat-top conical lenses 132_1 and 132_2 are opposite to each other, and the flat-top conical sides face each other. However, in the embodiment of FIG. 3A, the configurational directions of two flat-top conical lenses 132_1 and 132_2 in a shaping lens set 130A may be the same as each other, and flat-top conical surfaces face the light incident side. In the embodiment of FIG. 3B, the configurational directions of the two flat-top conical lenses 132_1 and 132_2 in a shaping lens set 130B may be the same as each other, and the flat-top conical surfaces face the light emitting side. In the embodiment of FIG. 3C, the configurational directions of the two flat-top conical lenses 132_1 and 132_2 in a shaping lens set 130C may be opposite to each other, but the flat-top conical surfaces face outwards. In other words, the disclosure does not limit the configurational directions of the two flat-top conical lenses in the shaping lens set.

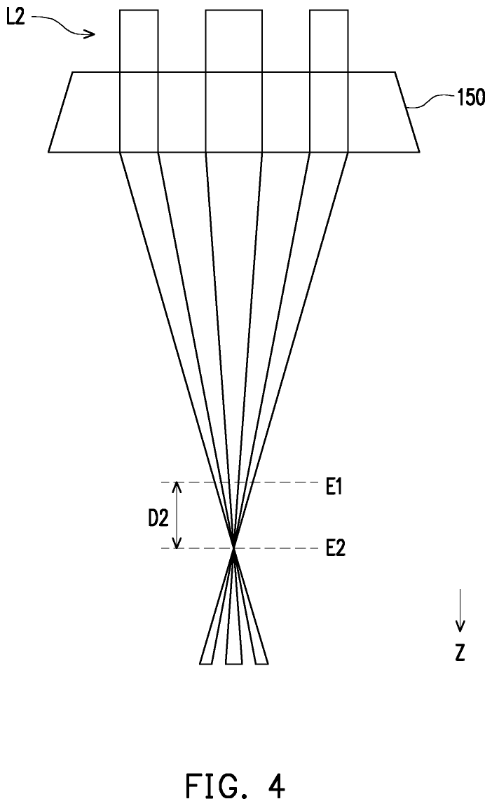

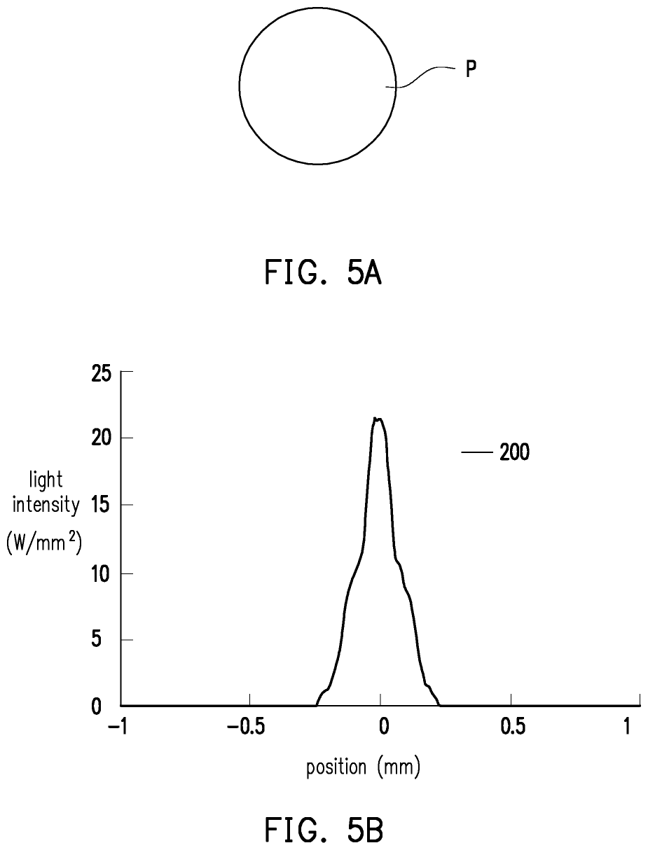

FIG. 4 is an enlarged view of a beam emitted from a telecentric flat-field focusing element according to an embodiment. FIG. 5A and FIG. 5B are respectively a light spot appearance and a light intensity distribution of a pattern beam in FIG. 4 when in a focused state. FIG. 6A and FIG. 6B are respectively a light spot appearance and a light intensity distribution of the pattern beam in FIG. 4 when in a defocused state. Please refer to FIG. 1, FIG. 2, and FIG. 4 to FIG. 6B. The enlarged view of the pattern beam L2 emitted from the telecentric flat-field focusing element 150 shown in FIG. 4 may be applied to the scanning light source module 100 shown in FIG. 1, so the following description will be taking the same as an example, but the disclosure is not limited thereto. It is worth mentioning that, in the embodiment, there is a distance D2 between the work plane E1 and a focal plane E2 of the telecentric flat-field focusing element 150. In detail, after the pattern beam L2 is transmitted, the pattern P presented by the pattern beam L2 passing through the telecentric flat-field focusing element 150 on the focal plane E2 of the telecentric flat-field focusing element 150 is a circular pattern, as shown in FIG. 5A. The relative relationship curve between the light intensity and the position of the pattern P shown in FIG. 5A may be represented by a curve 200 shown in FIG. 5B. On the other hand, after the pattern beam L2 is transmitted, the pattern P presented by the pattern beam L2 through the telecentric flat-field focusing element 150 on the work plane E1 is a composite light spot pattern having multiple parts, and there is spacing G between the parts, as shown in FIG. 6A. The relative relationship curve between the light intensity and the position of the pattern P shown in FIG. 6A may be represented by the curve 220 shown in FIG. 6B. In other words, when the work plane E1 is not located at the focal plane E2 of the telecentric flat-field focusing element 150 (i.e., when in the defocused state), the pattern formed by the pattern beam L2 may be maintained as the pattern transmitted by the shaping lens set 130, which has multiple parts (such as the dot pattern P1 and the ring pattern P2). In this way, the scanning light source module 100 may provide the pattern beam L2 having good uniformity and being an adjustable pattern to irradiate the target object 10, such that the weld 20 with good quality and uniform distribution may be formed on the irradiated part of the surface of the target object 10, so as to prevent material splashing or denting of the weld 20 in the welding process, thereby improving quality of the weld 20 and production efficiency.

In an embodiment, the distance D2 between the work plane E1 and the focal plane E2 of the telecentric flat-field focusing element 150 is greater than the Rayleigh length of the pattern beam L2. In other words, the energy distribution of the pattern beam L2 on the target object 10 may also be changed by adjusting the distance D2 between the work plane E1 and the focal plane E2 of the telecentric flat-field focusing element 150. The calculation method of the Rayleigh distance of the pattern beam L2 may be obtained by persons skilled in the art using numerical algorithm, so there will be no reiteration here.

In summary, in the scanning light source module of the disclosure, the outer diameter of the beam provided by the light emitting device may be adjusted by the beam reducing/expanding device. The pattern beam may be formed from multiple different patterns and have a more uniform energy distribution by the shaping lens set. In addition, the pattern beam may scan the target object at high speed by the scanning reflective mirror set and the telecentric flat-field focusing element. In this way, in the laser welding process, the weld with good quality and uniform distribution may be formed on the part of the surface of the target object irradiated by the pattern beam, so as to avoid material splashing or weld denting during the welding process, thereby improving weld quality and production efficiency.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A scanning light source module, adapted to provide a pattern beam to a target object located on a work plane, the scanning light source module comprising:
a light emitting device, adapted to provide a beam;
a beam reducing/expanding device, disposed on a transmission path of the beam and adapted to adjust an outer diameter of the beam;
a shaping lens set, disposed on the transmission path of the beam and adapted to convert the beam into the pattern beam, wherein a pattern presented by the pattern beam has a plurality of parts and there is a spacing between the parts;
a scanning reflective mirror set, disposed on a transmission path of the pattern beam and adapted to reflect the pattern beam to move along at least one direction; and
a telecentric flat-field focusing element, having an incident surface and disposed on the transmission path of the pattern beam, wherein the pattern beam is adapted to be reflected to different positions on the incident surface by a rotation of the scanning reflective mirror set, the pattern beam is transmitted to the target object by the telecentric flat-field focusing element, and there is a distance between the work plane and a focal plane of the telecentric flat-field focusing element.

2. The scanning light source module according to claim 1, wherein the light emitting device is a laser.

3. The scanning light source module according to claim 1, wherein the shaping lens set comprises two flat-top conical lenses.

4. The scanning light source module according to claim 3, wherein configurational directions of the two flat-top conical lenses are the same as each other.

5. The scanning light source module according to claim 3, wherein the configurational directions of the two flat-top conical lenses are opposite to each other.

6. The scanning light source module according to claim 5, wherein flat-top conical sides of the two flat-top conical lenses face each other.

7. The scanning light source module according to claim 1, wherein the distance is greater than a Rayleigh distance of the pattern beam.

8. The scanning light source module according to claim 1, wherein the pattern presented by the pattern beam on the work plane comprises a dot pattern and a ring pattern, and there is the spacing between the dot pattern and the ring pattern.

9. The scanning light source module according to claim 8, wherein a size ratio of the dot pattern to the ring pattern is changed according to the shaping lens set.

10. The scanning light source module according to claim 8, wherein the shaping lens set comprises two flat-top conical lenses, each of the two flat-top conical lenses has a flat-top surface and a conical surface, the beam is transmitted through the flat-top surface to form the dot pattern, and the beam is transmitted through the conical surface to form the ring pattern.

11. The scanning light source module according to claim 10, wherein an outer diameter of the ring pattern is changed according to a relative distance between the two flat-top conical lenses.

12. The scanning light source module according to claim 10, wherein the outer diameter of the ring pattern and the relative distance between the two flat-top conical lenses are inversely proportional.

13. The scanning light source module according to claim 1, wherein the scanning reflective mirror set comprises a first reflective lens and a second reflective lens, the first reflective lens is adapted to reflect the pattern beam to move along a first direction, the second reflective lens is adapted to reflect the pattern beam to move along a second direction, and the first direction is perpendicular to the second direction.

14. The scanning light source module according to claim 1, wherein an energy distribution of the pattern beam on the target object changes according to the distance.
